(19) United States
(12) Patent Application Publication
(10) Pub. No.: US 2009/0283227 A1
(43) Pub. Date: Nov. 19, 2009

(54) Clutch operated electric aircraft window with manual override

(75) Inventors: Nicholas C. Mohat, San Antonio, TX (US); Michael Spraggins, San Antonio, TX (US)

Correspondence Address: JACKSON WALKER, L.L.P., 112 E. PECAN, SUITE 2400, SAN ANTONIO, TX, 78205, US

(73) Assignee: MSA AIRCRAFT PRODUCTS LTD.

(21) Appl. No.: 12/384,318

(22) Filed: Apr. 2, 2009

Related U.S. Application Data
(60) Provisional application No. 61/127,374, filed on May 13, 2008.
(60) Provisional application No. 61/130,758, filed on Jun. 3, 2008.

(51) Int. Cl. E06B 9/24

(52) U.S. Cl. 160/369; 160/371

(57) ABSTRACT

A novel electrically driven window shade using an electromagnetic clutch and an override mechanism accessible to a passenger in the aircraft interior, whose shade is driven by an electric motor coupled to a drive sprocket through the electromagnetic clutch. The clutch and electric motor are typically wired in series with one another such that when the motor is energized the clutch is engaged, allowing the window shade to move between an opened and closed position. When the electric motor is de-energized, the clutch is disengaged and the novel override device may be used to manually move the shade between a raised or lowered position.

This application claims priority from, incorporates by reference, and is based upon the following provisional patent applications, Ser. No. 61/127,374, filed May 13, 2008, and Ser. No. 61/130,758, filed Jun. 3, 2008.

### FIELD OF THE INVENTION

Motor operated windows for vehicles, including aircraft, the windows having a clutch for engaging the motor to a shade and an override mechanism for moving the window shade when the motor is inoperable.

### BACKGROUND OF THE INVENTION

Windows for vehicles, including aircraft, frequently are contained in isolation from an aircraft cabin. That is to say, the shade of the aircraft window is sometimes behind a lens and not accessible to a passenger in an aircraft cabin. Thus, aircraft windows typically have a means to raise and lower the shade without direct manual contact between the shade and the passenger.

The shade may be raised manually through a mechanical mechanism, such as that set forth in U.S. Pat. No. 4,769,610, incorporated herein by reference. Electrical mechanisms are also provided to raise and lower the shade typically comprising a switch operated electric motor, engaging and powered by the electrical system of the aircraft.

### SUMMARY OF THE INVENTION

Applicants provide a novel electrically driven window shade using an electromagnetic clutch and an override mechanism accessible to a passenger in the aircraft interior.

Applicants provide a novel aircraft window whose shade is driven by an electric motor coupled to a drive sprocket through an electric clutch. The clutch and electric motor are typically wired in series with one another such that when the motor is energized the clutch is engaged, allowing the window shade to move between an opened and closed position. When the electric motor is de-energized, the clutch is disengaged and the novel override device may be used to manually move the shade between a raised or lowered position.

Applicants disclose a window for a vehicle, the vehicle including an aircraft. The window typically includes a frame, which may be curved to conform to the interior of the vehicle, and a motor for engaging the frame. The motor is typically electric and engages an electromagnetic clutch. The switch energizes and de-energizes the electromagnetic clutch and electric motor. The electric motor with the electromagnetic clutch engaged drives a shade having a shade rail, between a normally opened and a normally closed position. A drive system, such as sprockets and a belt, in which belt engages the shade rail, is provided for moving the shade between an opened and a closed position.

### BRIEF DESCRIPTION OF THE DRAWINGS

FIG. 1 is a perspective view of Applicants' shade assembly having an electric motor, electromagnetic clutch, and an override mechanism.

FIG. 1A is a front elevational partially cutaway view of a preferred embodiment of Applicants device featuring a drive system comprising a single drive sprocket, driven sprocket, and flexible belt on only one side of the frame.

FIG. 2 is a perspective view of the shade assembly illustrating in detail, the motor assembly, motor/gearbox, and the manner in which frame rails join at the ends thereof to define a corner.

FIG. 3 illustrates details of Applicants' override assembly and the manner in which it joins a driven belt and provides a manual override thumbwheel for moving the driven belt when the motor is de-energized.

FIG. 3A is a detail perspective view of the interior of the gearbox.

FIG. 4 is an exploded view of Applicants' shade assembly and the manner in which it joins a sidewall and a lens to form a portion of an interior of an aircraft.

FIG. 5 illustrates a close-up of the detail in which a thumbwheel of Applicants' override assembly is accessible through a sidewall panel so a passenger may move the shade up and down in the event of power failure to the electric motor that normally drives the shade assembly.

FIG. 5A illustrates a side cross-sectional view of a preferred embodiment of Applicant's device showing a fully recessed knob or thumb heel.

FIG. 6 is an alternative preferred embodiment replacing the thumbwheel with a pivotable rotating handle which may fold into an enclosure within the sidewall of the interior of the aircraft.

### DETAILED DESCRIPTION OF THE PREFERRED EMBODIMENT

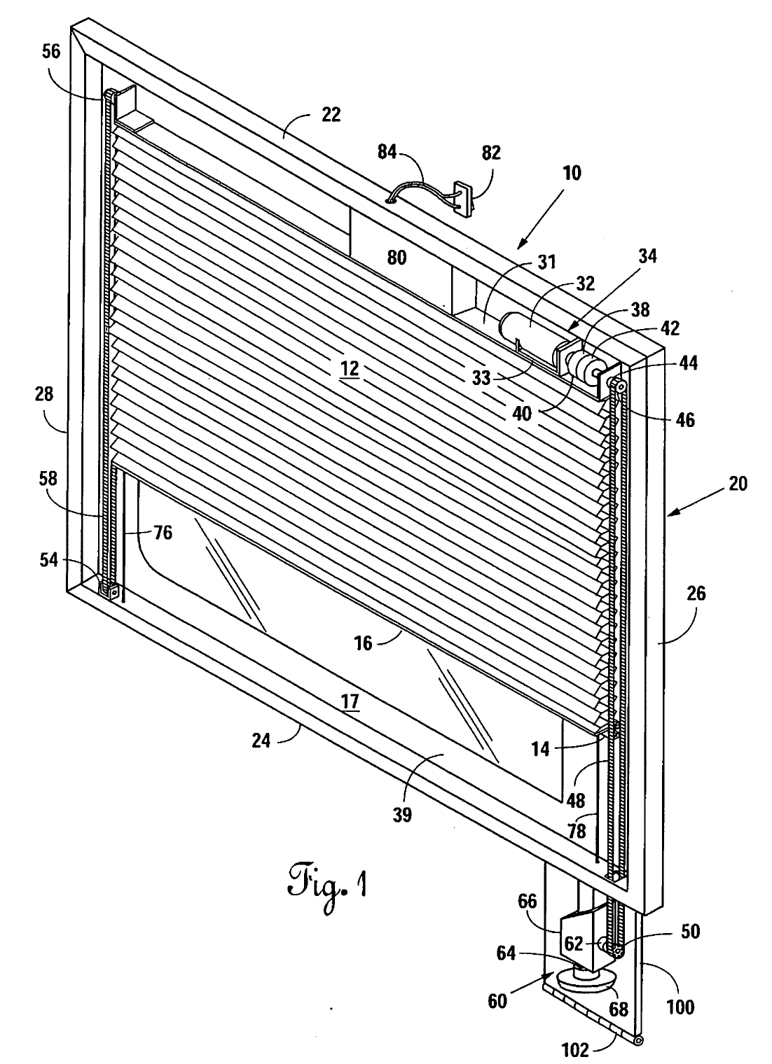

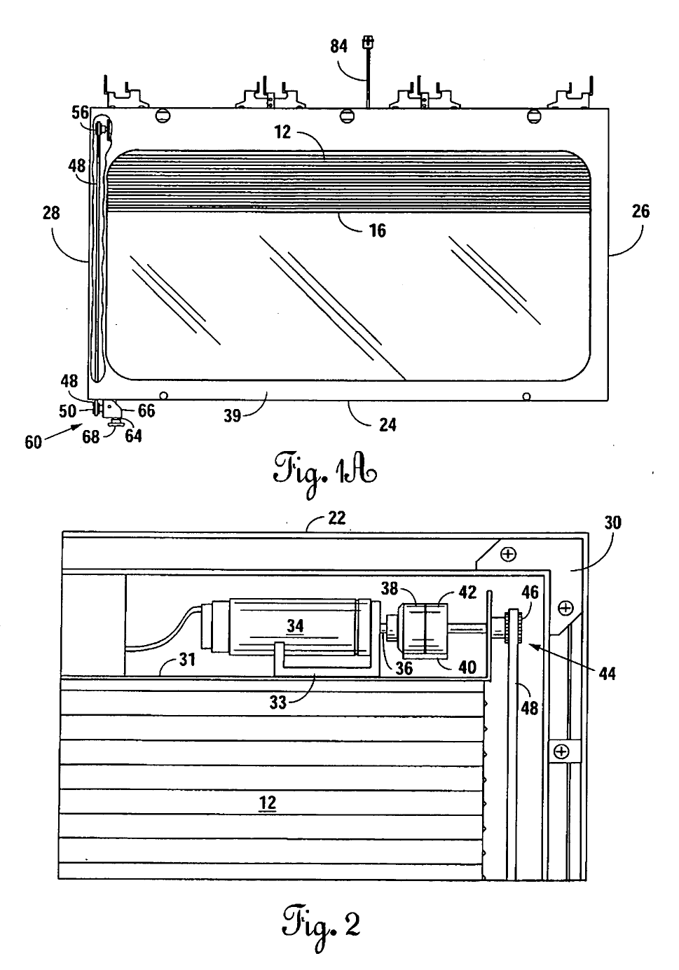

FIGS. 1-3 illustrate the overall structure and function of Applicants' novel shade assembly 10. It is one of the functions of an embodiment of Applicants' shade assembly to provide an electric powered aircraft window shade assembly 10, with a shade 12 that is electronically driven between an opened and closed position. An opened position would allow substantial visibility through at least one lens of the window and a closed position would substantially prevent light passing through a substantially opaque shade 12. Moreover, in an embodiment of Applicants' present invention, a motor assembly 32 drives the shade 12 between the opened and closed position, which motor assembly 32 may be passenger controlled through a switch 82, such as a momentary switch, in ways known in the art.

Turning now to FIGS. 1-3, it is seen that a shade rail 14 is provided with a lower edge face 16. A frame 20, typically rectangular, may comprise an upper frame rail 22, lower frame rail 24, right side frame rail 26, and left side frame rail 28.

Some of the structure and general environment of Applicants' present design may be found in U.S. Pat. No. 4,679,610, which is incorporated by reference herein. The frame rails of the rectangular frame may be engaged through the use of corner braces 30 (typically one at each corner). The frame may be curved slightly, in cross section, as is known in the art, to conform the shade assembly 10 to the curved shape of the fuselage interior of an aircraft.

Frame 20 provides mounting structure for other elements of Applicants' present design as set forth herein and may provide for mounting of shade 12 to upper frame rail 22 as by clips or other known structure. Moreover, a lens and/or a lens/reveal assembly may typically, but not necessarily, be engaged with an interior perimeter of the frame, the exterior perimeter being defined with respect to the interior of an aircraft. For example, in FIG. 1, the view is of the exterior perimeter or back of the shade assembly, which may also engage a lens or lens/reveal combination.

A motor assembly 32 may be provided whose function is to power the shade rail and thus move the shade between an open and closed position. Motor assembly 32 may include a motor/gearbox combination 34, an output shaft 36, a clutch 38 comprising at least a first plate or rotor assembly 40 and a second plate or armature assembly 42. The motor/gearbox combination 34 engages the first plate or rotor assembly 40. A driveshaft or load shaft 44 mounted to second plate or armature assembly 42 extends outward from the clutch and typically engages a drive means, such as a drive sprocket 46. Drive sprocket 46 may engage a flexible belt or drive belt 48, such as a belt for engaging the teeth of the drive sprocket. The motor/gearbox 34 may include the electric motor with the gears to step down the high r.p.m. of the motor to the output shaft 36.

Motor assembly 32 may be mounted to a mounting bracket 33, which mounting bracket in turn may be mounted to a mounting channel 31. The mounting channel may engage a frame member. In one embodiment, motor assembly 32 is mounted adjacent upper frame rail 22 with a longitudinal axis thereof parallel to the axis of the upper frame rail and with the drive sprocket adjacent one of the side rails for tracking drive belt 48 adjacent one of the side rails.

An example of a motor/gearbox combination 34 that may be used with Applicants' device includes Model No. 2224A036SR+22EK28:1 manufactured by Faulhaber. An example of a clutch 38 that may be used with an embodiment of Applicants' device includes an electromagnetic clutch, such as Model No. SO08 manufactured by Inertia Dynamics. The SO08 is a power on shaft, mounted clutch coupling that is used to couple two inline shafts, here output shaft 36, to load shaft 44. When motor 32 is energized and clutch 38 is engaged, drive sprocket 46 is turning. A preferred clutch is known as an electromagnetic, power on clutch, coupling the rotor and armature assemblies only when energized and decoupling when not subject to an electric current.

It is seen with reference to FIGS. 1, 2, and 3 that Applicants provide driven sprockets 50, 54, and 56. Driven sprocket 50 is mounted so that it may rotate adjacent a corner of the side rail and lower frame rail as seen in FIG. 1. Driven sprocket 50 is driven by drive sprocket 46 through engagement of the two sprockets through a flexible drive belt 48 as seen in FIG. 1A. In an alternate embodiment, a second drive belt 58 will engage a driven sprocket 54 mounted to a gearbox 66 as set forth in FIG. 1, and a driven sprocket 56 located adjacent the junction of upper frame rail 22 and side rail 28 as seen in FIG. 1. Drive belt 48 is fully engaged to a removed end of shade rail 14 (right end as seen in FIG. 1) with a clamp or other means known in the art. Likewise driven belt 58 is engaged with the other removed end of shade rail 14 (left end as seen in FIG. 1). Therefore, when motor/gearbox 34 is energized, the clutch is engaged and drive belt 48 will move shade rail 14 and shade between an upper and lower position.

A manual override assembly 60 is provided, whose function it is to manually move the shade between an upper and a lower position when the motor/gearbox combination 34 is not energized. When motor/gearbox combination 34 is not energized, the electromagnetic clutch is disengaged and output shaft 36 is uncoupled from lead shaft 44. Override assembly 60 allows one to manually move the shade rail 14 up and down as seen in FIG. 1 in a manner and with the structure as set forth in more detail below. Override assembly 60 may include gearbox 66 having a shaft 62 on which driven sprocket 54 is mounted and a shaft 64 on which a thumbwheel 68 is mounted. Shafts 62 and 64 engage gears of the gearbox.

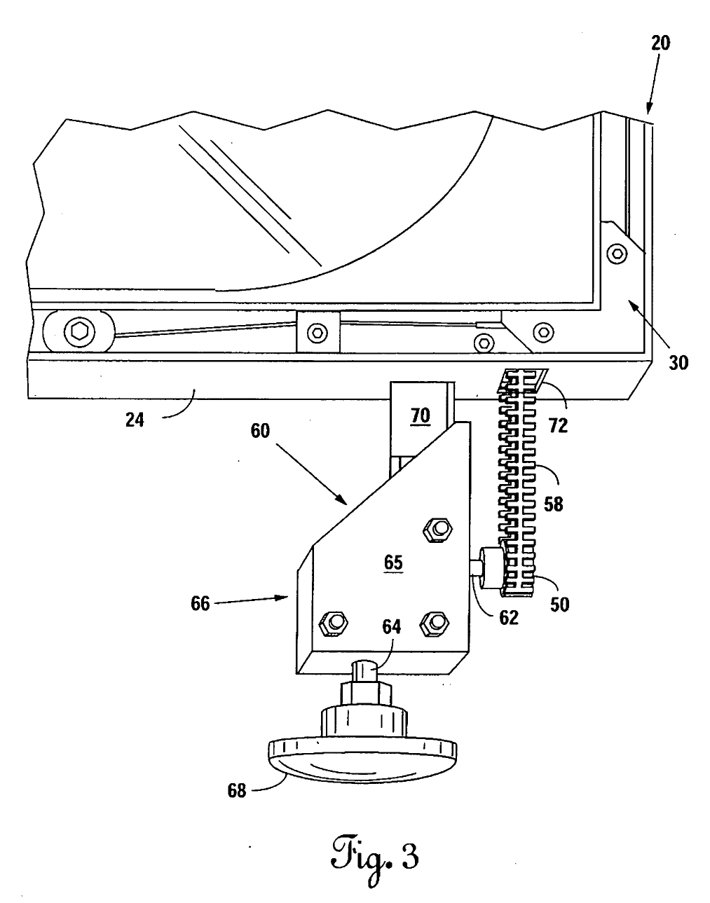

As seen in FIG. 3A, gearbox 66 may be comprised of gearbox housing 65, which engages shafts 62 and 64, which articulate with respect to housing, but are set perpendicular to one another. Inboard ends of shafts 62 and 64 may include a pair of bevel gears 61 and 67 meshed at 90°. Gearbox bracket assembly 70 may be engaged to gearbox housing 65 and the frame to maintain the shafts 62 and 64 as set forth above and as illustrated. A right angle bevel gear drive, such as illustrated in FIG. 3A, is available from Stock Drive Products/Sterling Instrument as Catalog No. S99RD1 MBE40-L1. The gears of the gearbox may have different circumferences to as to provide a mechanical advantage or disadvantage. They may be aligned at 90° as seen or other types of gears may have different orientations.

The gearbox bracket assembly 70 may be used to fixedly locate gearbox 66 with respect to the frame. In one embodiment, a cutout 72 is provided in the lower frame rail to allow driven belt 58 to extend downward below the rail and engage the gearbox 66, which is rigidly mounted so that it is located below the frame member, here the lower frame member. Moreover, gearbox bracket assembly 70 would typically align driven sprocket 54 with driven sprocket 56 and a removed edge of shade rail 14 so that driven belt (or drive belt) tracks parallel with and inside the side rail as illustrated in FIG. 1.

As seen in FIG. 1A, a preferred embodiment of Applicant's device may locate include the gearbox 66 on the same side as the motor/gearbox combination 34 and vertically below and aligned with drive sprocket 46. Further, Applicants have found, surprisingly, that the driven belt and driven sprockets may be eliminated, driving the shade rail from only one side. The override device may be located adjacent either the driven belt or the drive belt below the lower frame rail, above the upper frame rail or on either side. In such a preferred embodiment, there is no need for driven belt 58 or driven sprockets 54, 56 9 as on the left side of FIG. 1). That is to say, the gearbox 66 is placed below a lower frame rail cutout on the lower right side as seen in FIG. 1A. Leveling string assembly 74 alone has been shown to maintain the leveling of the shade rail as the motor drives the shade rail between the upper and lower positions.

Turning to FIG. 1, it is seen that a leveling string assembly 74 may be provided whose function it is to maintain the alignment of shade rail 14 as it moves up and down. Leveling string assembly 74 includes a first string 76 and a second string 78. The strings tie off at either end of the lower edge of lower frame rail, extend to the shade rail, crisscross and extend upwards to tie off, typically along upper frame rail 22. This assembly is known in the art and further details may be provided with reference to the '610 patent, as set forth above, which is incorporated herein by reference.

As seen in FIG. 1, an electronic control module 80 is provided, which module engages a switch 82, such as a momentary switch or a one touch switch 82 as seen in FIG. 1. A one touch switch will move the shade all the way up or down and a momentary switch will move the shade so long as the switch is held down. A wiring harness 84 is provided to wire the switch control module and motor drive gearbox so they are engaged with the power supply of the aircraft, in ways known in the trade.

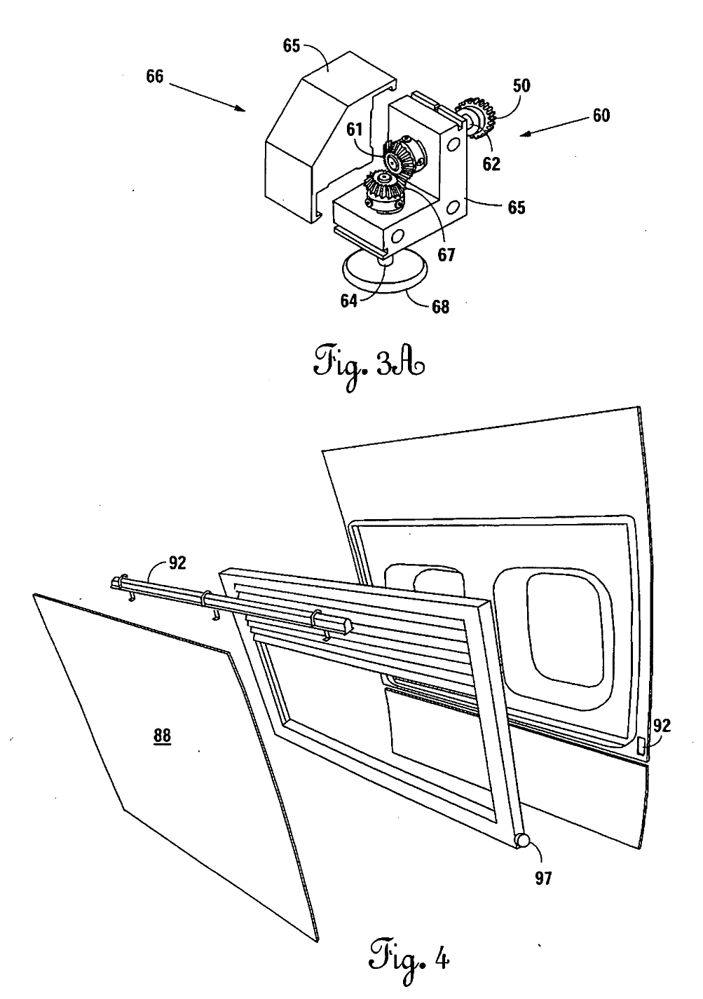

Turning to FIG. 4, it is seen that Applicants' shade assembly 10 may be used in conjunction with an inner lens 88 so as to seal the shade assembly substantially from the interior of the aircraft while allowing light to pass through. The lens would typically include a mask 39 usually plastic or sheet metal in ways known in the art which would cover up some or most of the mechanical parts seen in FIG. 1, leaving substantially a view only of the shade and shade rail. Moreover, an inner sidewall panel 86 may be provided with a recess therein and which Applicants' shade assembly 10 may fit into as seen in FIG. 4. Light assembly 90 is also illustrated in FIG. 4, which typically would engage the aircraft's electrical system to energize a light, which may be controlled by the pilot and/or passenger.

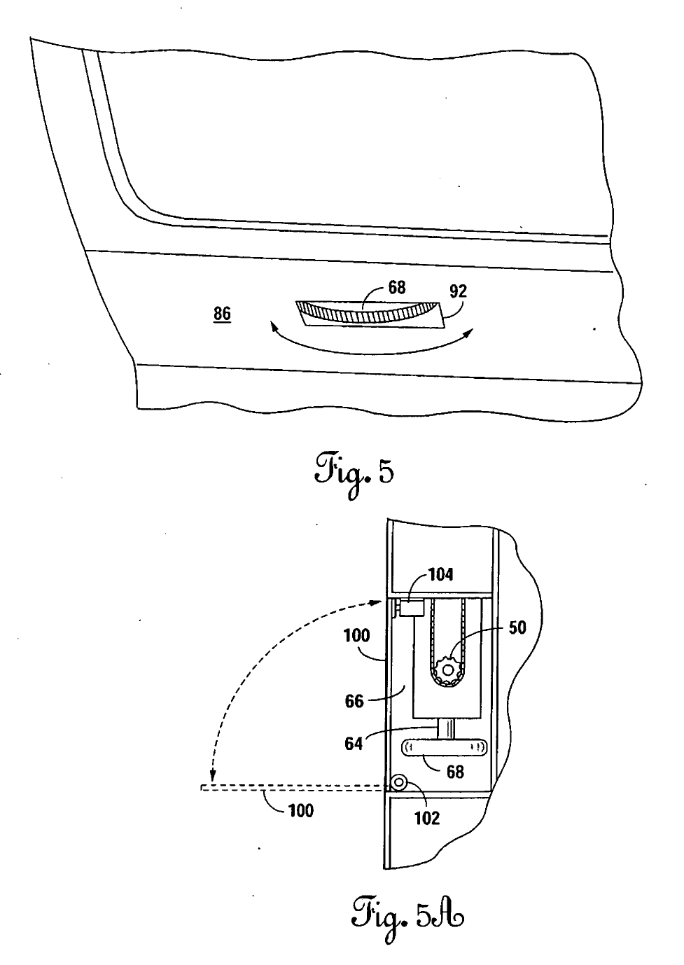

As seen in FIGS. 4 and 5, sidewall panel 86 may have a cutout 92 therein, which cutout would be located adjacent thumbwheel 68, so that the thumbwheel is exposed and may be turned by a thumb, as for example, when the motor gearbox is not energized. That is to say, cutout 92 allows the rotation of thumbwheel 68 to move the shade rail in the event that no power is getting to the frame assembly. Without power, the clutch is “out” and moving the shade manually will move the shade, but will not rotate the motor. That is to say, the clutch will relieve the override of driving the motor.

A thumbwheel is located fully recessed (not partially exposed as in FIGS. 4 and 5) into the sidewall of the interior of the aircraft. In this embodiment, an access flap or access door 100 is provided in the interior sidewall of the aircraft. Opening the door 100 will provide access to the thumb wheel or other rotation means provided at the gearbox 66. The use of the fully recessed thumb wheel combined with the door, the door typically in the plane of the surrounding walls of the sidewall of the aircraft interior will somewhat disguise the existence of the handle. A preferred door 100 includes a hinge and a Tutch Latch, mounted to the inside (not seen from the aircraft interior). This latch is a touch to close, touch to open, concealed catch that eliminates the need for external knobs or pulls.

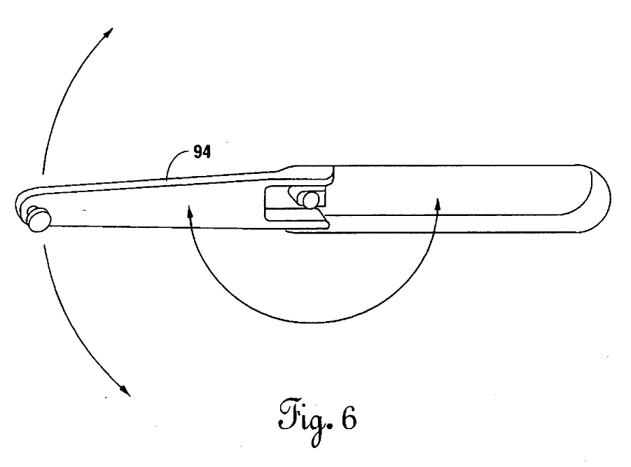

Shaft 64 may have a handle 94, in one embodiment a pivoting handle as seen in FIG. 6, which would (like the thumbwheel) be accessible from outside sidewall panel 86. Enclosure 96 may be provided so that, if the handle includes pivoting handle 94, it may fold in to enclosure 96 so as to be generally recessed into sidewall panel 86. The use of the term “thumbwheel” is intended to include a handle or any other conventional structure by which a shaft may be rotated.

The motor may be electric, hydraulic or pneumatic, with means typically provided to engage the clutch when the motor is energized, be it by electricity, fluid or air. The shade material used is preferably the hexagonal shade or other channel or tubular type shade material similar to that described in the '610 patent. The drive belt may be any flexible member and the driven sprockets may be any equivalent means, such as belt drive and sprockets defining the shaped grooves.

FIG. 4 illustrates a direct drive 97 having a thumbwheel. Direct drive 97 includes a shaft with a thumbwheel 97 at one end, the shaft typically mounted to and going through the side rail and connected directly to a driven sprocket. There is no gearbox or direction change for the thumbwheel nor is there, of course, any mechanical advantage or direction change. It is still, however, an override assembly that allows manual movement of a shade that is normally powered by electric, pneumatic, hydraulic or other means.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A window for a vehicle, the window comprising:
a frame;
a motor engaging the frame;
an electromagnetic clutch engaging the electric motor;
a switch for energizing and de-energizing the electromagnetic clutch and the electric motor;
a shade, engaging the frame, the shade moveable between a substantially collapsed and a substantially extended position; and
a drive system for engaging the electromagnetic clutch, the drive system further engaging the frame and the shade to move the shade between the collapsed position and the extended position.

2. The window of claim 1 further comprising an override device for moving the shade between the collapsed position and extended position when the motor and clutch are not energized.

3. The window of claim 2, wherein the override device includes a manually rotatable member engaging the drive system to move the shade, responsive to rotation of the manually rotatable member, between the collapsed and extended positions.

4. The window of claim 3, wherein the override device includes a gearbox, including an a first shaft and a second shaft and wherein the first shaft includes the manually rotatable member and the second shaft engages the drive system.

5. The window of claim 4, wherein the first shaft and second shaft of the gearbox are substantially perpendicular to one another.

6. The window of claim 5, wherein the drive system includes at least a drive sprocket and driven sprocket, the drive sprocket and driven sprocket connected by a flexible member, the flexible member for engaging the shade.

7. The window of claim 6, wherein the shade includes a shade rail, the shade rail engages the flexible member, the frame is rectangular, further including alignment structure for maintaining the shade rail in alignment with the frame as the shade moves between the collapsed and extended positions.

8. The window of claim 3, wherein the drive system includes a drive sprocket and a driven sprocket and wherein the manually rotatable member engages one of the drive or driven sprocket and rotates in a plane parallel to the plane of rotation of the driven sprocket.

9. The window of claim 1, wherein the frame is rectangular, having a top member, two curved side members, and a bottom member, wherein the shade includes a fixed edge attached to the frame, two side edges, and a free edge, the shade further includes a shade rail attached to the free edge, wherein the drive system includes a drive sprocket engaging the clutch and a driven sprocket spaced apart from the drive sprocket, engaging the frame, and a first flexible member extending between the drive and driven sprocket, the flexible member engaging the shade rail to move the shade between the collapsed and extended positions; the drive and driven sprocket adjacent one of the side edges.

10. The window of claim 9, further including an override device for moving the shade between the collapsed position and extended position when the motor and clutch are not energized.

11. The window of claim 10, wherein the override device includes a manually rotatable member engaging the drive system to move the shade, responsive to the rotation of the manually rotatable member, between the collapsed and extended positions.

12. The window of claim 11, wherein the override device further includes a gearbox, including an input shaft and an output shaft, and wherein the input shaft engages the manually rotatable member and the output shaft engages the drive system.

13. The window of claim 12, wherein the first shaft and the second shaft are substantially perpendicular to one another.

14. The window of claim 13, further including alignment members for maintaining the shade rail substantially parallel to the top and bottom frame members as the shade moves between the collapsed and extended positions.

15. The window of claim 14, wherein the alignment members include a pair of cords, each engaging the top and bottom member at spaced positions and each engaging the shade rail, crisscrossing on another at the shade rail.

16. The window of claim 14, wherein the alignment members include a third and fourth toothed sprocket connected by a second toothed belt adjacent the edge opposite the drive and driven sprockets, and a shaft connecting one of the drive or driven wheel with one of the third or fourth toothed sprockets.

17. The window of claim 9, wherein the shade material is substantially tubular in cross-section when at least partially between the collapsed and extended positions.

18. The window of claim 4, wherein the override device includes a gearbox, including a first shaft and a second shaft and wherein the first shaft includes the manually rotatable member and the second shaft engages the drive system, and wherein the shade material is substantially tubular in cross-section when between the collapsed and extended positions.

19. The window of claim 18, wherein the gears of the gearbox have different circumferences.

20. The window of claim 5, wherein the input shaft and output shaft of the gearbox are substantially perpendicular to one another, wherein the gears of the gearbox have different circumferences.

21. The window of claim 3, wherein the manually rotatable member is fully recessed into an aircraft interior sidewall adapted to engage the frame, the sidewall having a hinged door with a Tutch Latch for providing access to the manually rotatable member.

22. An aircraft window for mounting into a sidewall of an aircraft interior, the sidewall having a recess for receiving the aircraft window and comprising:
a curved frame;
an electric motor engaging the frame;
an electromagnetic clutch engaging the electric motor;
a switch for energizing and de-energizing the electromagnetic clutch and the electric motor;
a shade, engaging the frame, the shade moveable between a substantially collapsed and a substantially extended position;
a drive system for engaging the electromagnetic clutch, the drive system further engaging the frame and the shade to move the shade between the collapsed position and the extended position; and
an override device comprising a gearbox assembly for manually moving the shade between the collapsed position and extended position when the electric motor and electromagnetic clutch are not energized, the gearbox having a thumbwheel, the gearbox mounted so that the thumbwheel is behind the access door.
